(19) United States
(12) Patent Application Publication
(10) Pub. No.: US 2015/0380703 A1
(43) Pub. Date: Dec. 31, 2015

(54) BATTERY SEPARATOR

(71) Applicant: LENZING AKTIENGESELLSCHAFT, A-4860 Lenzing (AT)

(72) Inventors: Marco Gallo, Vöcklabruck (AT); Peter Andrew Slater, Warwickshire (GB); Chris Potter, Little Eaton Derby (GB)

(73) Assignee: LENZING AKTIENGESELLSCHAFT, A-4860 Lenzing (AT)

(21) Appl. No.: 14/769,570

(22) PCT Filed: Feb. 22, 2013
(86) PCT No.: PCT/EP2013/053580

§ 371 Date: Aug. 21, 2015

(51) Int. Cl. H01M 2/16

(52) U.S. Cl. CPC H01M 2/1626

(57) ABSTRACT

The present invention relates to a battery separator, comprising fibers of the lyocell genus, wherein said lyocell fibers are mercerised. The present invention furthermore relates to novel lyocell fibers useful for battery separators, as well as batteries comprising the inventive battery separator.

### BACKGROUND OF THE INVENTION

### Field of the Invention

The present invention relates to the field of batteries, including alkaline (primary and secondary) and lithium batteries, which include separators comprising a porous layer including polymeric fibers.

Such separators serve to prevent an electrical connection between the anode and the cathode of the battery, or a short circuit.

Cellulosic fibers are widely employed in battery separators due to their ability to absorb and retain the electrolytes.

It is, for example, known to employ webs made from pulp or from rayon (viscose) fibers in battery separators.

The use of lyocell fibers in battery separators has been disclosed in EP 0 572 921 A1, US 2007/0014080 A1, US 2010/0310921 and US 2009/0017385 A1. WO 97/37392 discloses a battery separator made from a cellulose film formed from a solution of cellulose in an amine oxide. Further state of the art is provided by U.S. Pat. No. 5,700,700 and DE 198 55 644.

European patent application 1 216 5714.2 (not pre-published) proposes the use of fibers of the lyocell genus with specific R10 and R18-values as well as a specific hemicellulose content in battery separators.

Mercerising cellulosic fibers is well-known in the textile industry for modifying yarns and fabric properties and achieve special performances. In short, mercerising means the treatment of the fiber, yarn or fabric with an alkaline solution, especially NaOH-solution. The effects of mercerisation on the fiber structure of lyocell, modal and viscose fibers have, inter alia, been discussed in Stana-Kleinschek et al., Correlation of regenerated cellulose fibers morphology and surface free energy components, Lenzinger Berichte 82 (2003), 83-95 and Colom, X., Carrillo, F., Crystallinity changes in lyocell and viscose-type fibers by caustic treatment, Europ. Polymer J. 38 (2002), 2225-2230. Mercerisation of fabrics containing lyocell fiber is disclosed in WO 95/024524 A1.

Especially in the case of alkaline batteries, the battery separator is required to have good chemical stability in the presence of strong electrolytes (such as 30-40% KOH). Further details about the requirements of battery separators in various types of batteries are disclosed in e.g. WO 2007/041312.

Furthermore, some of the cellulosic fibers proposed so far to be used in a battery separator (like rayon or mercerised pulp) have poor fibrillation ability and, therefore, do not allow obtaining battery separators with the desired properties in terms of density, porosity and dimensional stability.

It is, therefore, still desired to make battery separators with cellulosic fibers having an enhanced resistance towards alkali solutions.

Accordingly, in one aspect the present invention provides a battery separator, comprising fibers of the lyocell genus, wherein said lyocell fibers are mercerised.

Furthermore, the present invention provides the use of a mercerised lyocell fiber in a battery separator.

The present invention also provides a mercerised lyocell fiber, exhibiting a fiber length of 2-10 mm.

Finally, the present invention provides a battery, preferably an alkaline battery, comprising the battery separator according to the present invention.

### DESCRIPTION OF RELATED ART

### Short Description of the Drawings

FIGS. 1 to 4 demonstrate the effect of the mercerisation of lyocell fibers on alkali resistance in terms of R10-value (FIGS. 1 and 3) and R18-value (FIGS. 2 and 4).

FIG. 5 shows the results of a Schopper-Riegler test on non-mercerised and mercerised lyocell fiber.

### DETAILED DESCRIPTION OF THE INVENTION

It has surprisingly been found that mercerised lyocell fibers exhibit a much better resistance to electrolytes of especially alkaline batteries than standard cellulosic fibers hitherto proposed for battery separators.

It has been found that mercerised pulp (which is a cellulosic fiber, but not a man-made cellulosic fiber that has been spun from a cellulose-containing solution, like lyocell fiber) exhibits high alkali resistance when used in a battery separator, but exhibits a poor fibrillation ability (cf. U.S. Pat. No. 7,781,104 B2). Apparently, the mercerisation treatment performed on the pulp negatively influences the fibrillation ability of the pulp.

In contrast thereto, it has been found that mercerised lyocell fibers not only exhibit high alkali resistance when used in a battery separator, but also high fibrillation ability.

Cellulosic fibers of the lyocell genus are well known for their fibrillation ability and are employed in battery separators. Lyocell fibers are spun from a solution of cellulose in a tertiary amine-oxide.

Thanks to the fine and long fibrils, the separators made with such fibers have a suitable porosity, the ions mobility inside the battery is very good and the efficiency of the battery is high. The fibrils interlace very well during paper making and form a dense structure with low shrinkage and high dimensional stability. Moreover the average size of the pores is small, and this represents a barrier for dendrites.

The R10-value and the R18-value of the lyocell fibers employed according to the present invention is preferably as follows:

R10>87%, preferably >93%

R18>95%, preferably >98%.

As known to the skilled artisan, the R10-value of a cellulosic substrate is the amount of undissolved residue when exposing the substrate to 10% NaOH R18 reflects the amount of undissolved residue when exposing the substrate to 18% NaOH. Both values can be measured according to DIN 54355.

All values given within this application for R10 and R18 are wt. %.

The R10 and R18-values given above are very high. Surprisingly, mercerised lyocell fibers having these properties still not only exhibit high alkali resistance when used in a battery separator, but also high fibrillation ability.

When producing battery separators comprising lyocell fibers meeting the above specifications, it was found that the Reduction by Weight of the separator in 40%/KOH was significantly reduced.

Furthermore, separators containing the above-specified fibers have lower Reduction by Area in 40% KOH compared to separators containing other cellulosic fibers.

Lyocell fibers with the above-specified properties have also a high degree of fibrillation when they are refined with the conventional beating systems. For example, the Canadian Standard Freeness (CSF) of the refined fibers is below 700 ml, or preferably below 500 ml.

The battery separator according to the present invention may comprise a mixture of mercerised lyocell fibers and, especially a mixture of mercerised lyocell fibers exhibiting the R10-values and R18-values as set out above.

The amount of the lyocell fibers fulfilling the above requirements in the separator may range from 1% to 100%, preferably 15% or more, 25% or more, 40% or more, or 50% or more.

The separator may comprise other constituents known to the skilled artisan, such as PVA fibers and PVA binders, pulp, non-mercerised viscose fibers or non-mercerised lyocell fibers.

The separator may be of any known design, such as a monolayer or multi-layer design.

In multi-layer structures at least one layer should be a nonwoven layer.

In such embodiments, there may be one or more additional layer(s) which can be selected from the group consisting of nonwovens or microporous layers (films), for example cellophane, PVA, polyamide, polyester or polyolefins.

In some embodiments the layers may be glued or thermally bonded together. Each layer may be coated with particles (like inorganic particles), may be grafted, treated with surfactants or corona treated. This kind of treatment may be symmetrical or asymmetrical, as described in US2012/028103A1.

Moreover the separator may include functional substances that have an “ions-trapping” function. They can selectively block molecules that reduce the battery performance (US2011/0117413A1).

It was found that battery separators comprising the lyocell fibers fulfilling the requirements according to the present inventions exhibit advantageous properties, such as
A Reduction by Weight in KOH of <3.5%, preferably 2.5% or less
A Reduction by Area in KOH of <3.0%, preferably 1.0% or less and/or
A Frazier Air Permeability of <50 cm³/cm²/s, preferably 20 cm³/cm²/s, most preferred from 3.5 cm³/cm²/s to 15 cm³/cm²/s.

The lyocell fibers to be employed according to the present invention may exhibit a titer in the range of 0.2-10 dtex, preferably 0.2-2 dtex. The length of the fibers may be in the range of 1-20 mm, preferably 2-10 mm. The diameter of the fibrils after refining the fibers may be between 50 nm and 10.000) nm.

A mercerised lyocell fiber fulfilling the requirements exhibiting a length of from 2 to 10 mm has not been proposed before.

Preferably, the R10-value and the R18-value of the lyocell fiber according to the present invention is as follows:

R10>87%, preferably >93%

R18>95%, preferably >98%.

The mercerised lyocell fibers employed according to the present invention can be produced by mercerising lyocell fibers according to procedures known to the skilled artisan as such.

Typically, mercerisation is carried out with a NaOH-solution. The concentration of NaOH in the solution may preferably be from 5 wt. % to 20 wt. %. The duration of the treatment (residential time of the fibers in the treatment bath) may preferably be from 120 to 480 seconds.

Mercerisation may be carried out within the fiber production line just before the cutting step, where the fibers are still in the form of continuous filaments called “tow”. Alternatively, mercerisation may be carried out in the fiber production line after cutting, when the fibers are already in the form of “staple” or “short cut” fiber. Of course, mercerisation can also be carried out off-line.

The mercerisation can be applied to any type of lyocell fibers, independently from the pulp types or other conditions used for the production of the fibers. If as the starting material for mercerisation fibers are used the R10 and R18-values of which are already high, notably R10>83%, preferably >84% and R18>93%, preferably >94%, excellent results can be obtained. The hemicellulose content of such fibers may preferably be <3%, as determined by two step sulphuric acid hydrolysis followed by quantification of the obtained monosaccharides by anion exchange chromatography.

Fibers with such high R10 and R18-values can be produced by using cellulosic starting materials, especially pulps or pulp mixtures, having corresponding properties in terms of R10-value, R18-value and hemicellulose content, respectively.

Especially, for making lyocell fibers with such high R10- and R18-values
All components of the cellulosic starting material should exhibit

R18>94%,

R10>85% and

Hemicellulose <3%
At least 50% in weight of the cellulosic starting material should exhibit

R18>96%,

R10>90% and

Hemicellulose <3%.

In order to produce lyocell fibers with a very high R10- and R18-value, at least 50% in weight of the cellulosic starting material should exhibit

R18>98%,

R10>97% and

Hemicellulose<1%

Pulps fulfilling the above requirements are commercially available and/or can be produced by the skilled artisan according to the respective needs of the production, see for example US 2009/0312536 A1 or WO 2005/118950.

The cellulosic starting material may also include cotton linters.

Pulps fulfilling these requirements are commercially available and/or can be produced by the skilled artisan according to the respective needs of the production, see for example US 2009/0312536 A1 or WO 2005/118950.

### Examples

### Test Methods

### Tests on Paper:

### Basis Weight

Measured according to EDANA standard WSP130.1

### Thickness

Measured according to ASTM D1777

Density Calculated: Density(g/cm³)=(Basis Weight[g/m²]/10000)/(Thickness [μm]/10000)

### Alkali Proof (Area Shrinkage Rate in KOH)

Procedure:
cut a square sheet 120 mm×120 mm (A1). Cut carefully the specimen where the paper is uniform.
immerse it in 40% KOH solution at 70° C.
keep in the bath for 8 hours
measure the area of the wet sample (A2)

Area shrinkage rate(%)=(A1−A2)/A1×100

Alkali Proof (Weight Reduction Rate in KOH)

Procedure:
cut one or more pieces of separator with a weight of approximately 5 g
dry the sample at 80° C. for 1 hour
weigh the dried sample (W1)
immerse it in 40% KOH solution at 70° C.
keep in the bath for 8 hours
wash the sample with water
dry the sample at 80° C. for 1 hour
weigh the dried sample (W2)

Weight reduction rate(%)=(W1−W2)/W1×100

### Frazier Air Permeability

Air permeability was measures according to JIS 1096-6,27.

The differential pressure of the air flow passing through the material was 0.5 inches of water.

### Porosity

It was calculated dividing the paper basis weight (g/m²) by the polymer density (g/cm³) and by the paper thickness (μm), multiplying by 100 and finally subtracting the result by 100.

Porosity(%)=100−(basis weight/[density×thickness]×100)

### Manufacture of Lyocell Fibers

Lyocell fibers were manufactured according to methods known as such to the skilled artisan from different pulps. The properties of the pulps employed, their respective amount in the fiber produced therefrom, and the properties of the resulting fibers are listed in the following table:

TABLE 1

| | | | Fiber Examples | | | | | | | |
|---|---|---|---|---|---|---|---|---|---|---|
| | | | (Percent of respective Pulp type in Fiber) | | | | | | | |
| | | ref. | A | G | H | B | F | C | D | Q |
| Pulp type | | | | | | | | | | |
| Pulp type | Xylan, % | 2.6 | | | | | | | | |
| 1 | Mannan, % | 0.7 | 100 | | | | | | | |
| | Tot. | 3.3 | | | | | | | | |
| | Hemicellulose,% | | | | | | | | | |
| | R10, % | 82.2 | | | | | | | | |
| | R18, % | 92.7 | | | | | | | | |
| Pulp type | Xylan, % | 7.3 | | 100 | 50 | 20 | | | | |
| 2 | Mannan, % | 5.3 | | | | | | | | |
| | Tot. | 12.6 | | | | | | | | |
| | Hemicellulose,% | | | | | | | | | |
| | R10, % | 83.3 | | | | | | | | |
| | R18, % | 89.4 | | | | | | | | |
| Pulp type | Xylan, % | 2.5 | | | 50 | 80 | 100 | 50 | | |
| 3 | Mannan, % | 0.4 | | | | | | | | |
| | Tot. | 2.9 | | | | | | | | |
| | Hemicellulose,% | | | | | | | | | |
| | R10, % | 85.9 | | | | | | | | |
| | R18, % | 94.9 | | | | | | | | |
| Pulp type | Xylan, % | 2.4 | | | | | | 50 | 100 | |
| 4 | Mannan, % | 0 | | | | | | | | |
| | Tot. | 2.4 | | | | | | | | |
| | Hemicellulose,% | | | | | | | | | |
| | R10, % | 92.6 | | | | | | | | |
| | R18, % | 97.2 | | | | | | | | |
| Pulp type | Xylan, % | 1.6 | | | | | | | | 50 |
| 5 | Mannan, % | 0.2 | | | | | | | | |
| | Tot. | 1.8 | | | | | | | | |
| | Hemicellulose,% | | | | | | | | | |
| | R10, % | 93.6 | | | | | | | | |
| | R18, % | 97.4 | | | | | | | | |
| Pulp type | Xylan, % | 0.5 | | | | | | | | 50 |
| 6 | Mannan, % | 0 | | | | | | | | |
| | Tot. | 0.5 | | | | | | | | |
| | Hemicellulose,% | | | | | | | | | |
| | R10, % | 98.6 | | | | | | | | |
| | R18, % | 99.5 | | | | | | | | |

| | | | | | | | | |
|---|---|---|---|---|---|---|---|---|
| Fiber properties: | | | | | | | | |
| dtex | 1.7 | 1.7 | 1.3 | 1.7 | 1.3 | 1.7 | 1.7 | 1.3 |
| length, mm | 4 | 5 | 5 | 4 | 5 | 4 | 5 | 5 |
| Xylan, % | 2 | 7.3 | 4.3 | 3 | 1.6 | 2.1 | 2.6 | 1.1 |
| Mannan, % | 0.2 | 4.9 | 2.3 | 1.6 | 0.2 | 0.2 | 0.1 | 0.1 |
| Tot. Hemicellulose, % | 2.2 | 12.2 | 6.6 | 4.6 | 1.8 | 2.3 | 2.7 | 1.2 |
| R10, % | 80.1 | 75.2 | 78 | 82.4 | 79.9 | 85.7 | 88.1 | 89.7 |
| R18, % | 93.3 | 83.4 | 88.8 | 92.3 | 93.8 | 95.2 | 96.4 | 97.5 |

### Mercerisation of Fibers

Lyocell fibers produced from the same starting materials and spun under the same conditions as for examples B and C above were mercerised in aqueous NaOH-solutions in the tow form. The fibers were then cut to a length of 3 mm. The mercerisation process employed the following parameters:

| | |
|---|---|
| Concentration of NaOH (%): | 5 - 10 - 15 - 20 |
| Residential time (s): | 120~240 - 480 |
| Bath temperature (° C.): | 25 |

The alkali resistances of the mercerised fibers in terms of R10-value and R18-value were determined.

The respective test regimes and results in terms of R10-value and R18-value are summarized in the following table:

TABLE 2
Test Regimes for mercerisation and results

| | | Mercerisation conditions | | | | |
|---|---|---|---|---|---|---|
| | | NaOH | | Bath | | |
| | | concen- | Resi- | Temper- | Alkali | |
| | Starting | tration | dential | ature, | Resistance | |
| example | fibers | (%) | time (s) | ° C. | R10% | R18% |
| C-1-0 | Example C | 0 | 0 | 25 | 85.7 | 95.2 |
| C-1-1 | Example C | 5 | 120 | 25 | 87.0 | 97.0 |
| C-1-2 | Example C | 10 | 120 | 25 | 91.3 | 98.4 |
| C-1-3 | Example C | 15 | 120 | 25 | 94.5 | 98.9 |
| C-1-4 | Example C | 20 | 120 | 25 | 94.5 | 98.7 |
| C-2-4 | Example C | 5 | 240 | 25 | 87.0 | 96.9 |
| C-3-1 | Example C | 10 | 240 | 25 | 93.5 | 98.6 |
| C-2-6 | Example C | 15 | 240 | 25 | 96.5 | 99.3 |
| C-3-2 | Example C | 20 | 240 | 25 | 96.8 | 98.5 |
| C-3-3 | Example C | 5 | 480 | 25 | 87.0 | 96.9 |
| C-3-4 | Example C | 10 | 480 | 25 | 95.3 | 98.6 |
| C-3-5 | Example C | 15 | 480 | 25 | 96.7 | 98.7 |
| C-3-6 | Example C | 20 | 480 | 25 | 96.9 | 98.6 |
| B-4-0 | Example B | 0 | 0 | 25 | 82.4 | 92.3 |
| B-4-1 | Example B | 5 | 240 | 25 | 83.3 | 95.0 |
| B-4-2 | Example B | 10 | 240 | 25 | 93.4 | 97.2 |
| B-4-3 | Example B | 15 | 240 | 25 | 95.4 | 97.7 |
| B-4-4 | Example B | 20 | 240 | 25 | 94.8 | 97.9 |

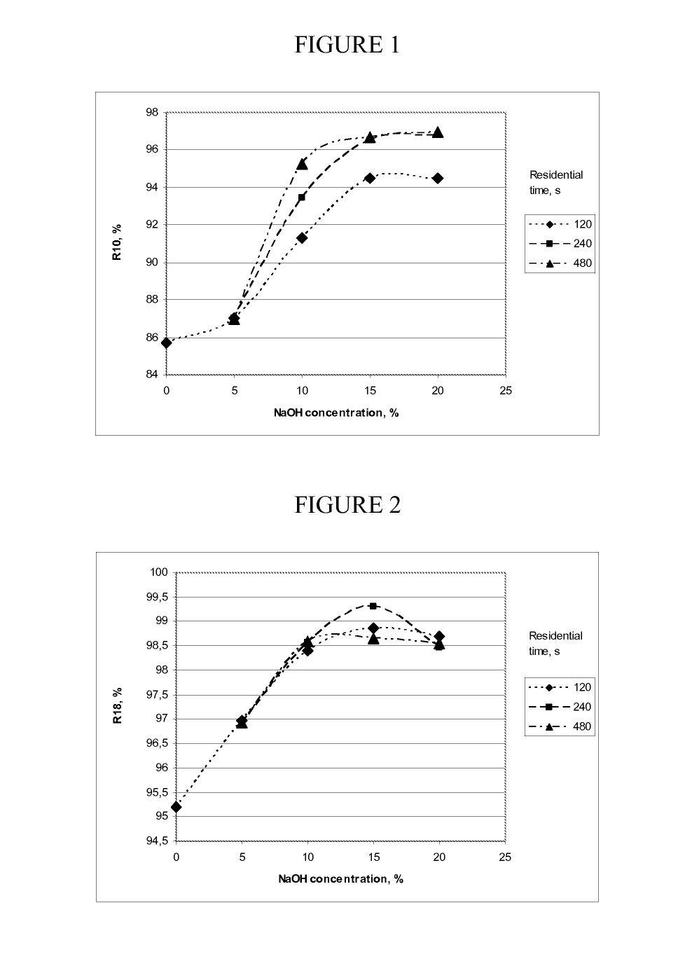

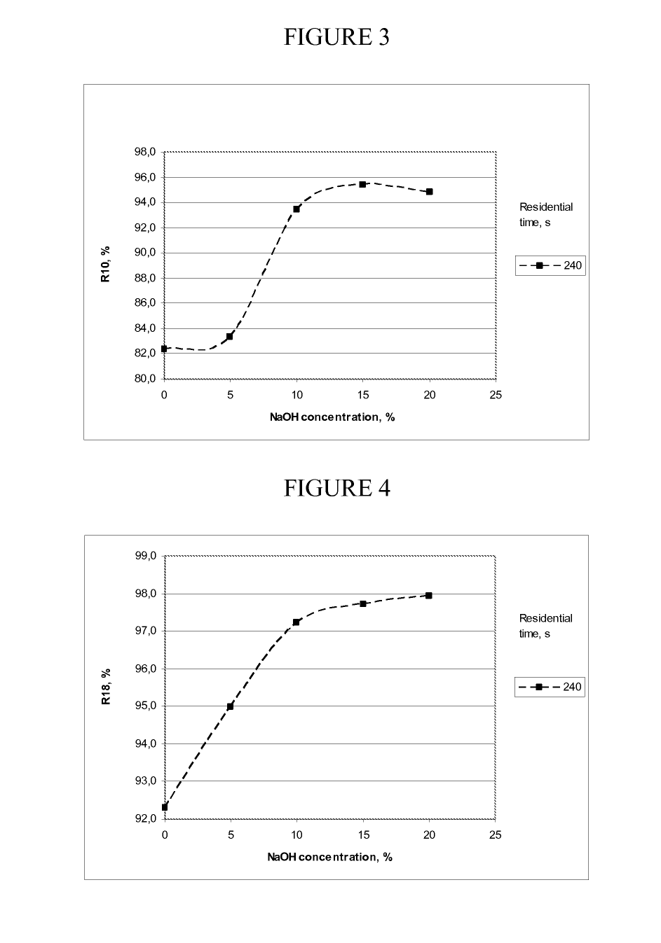

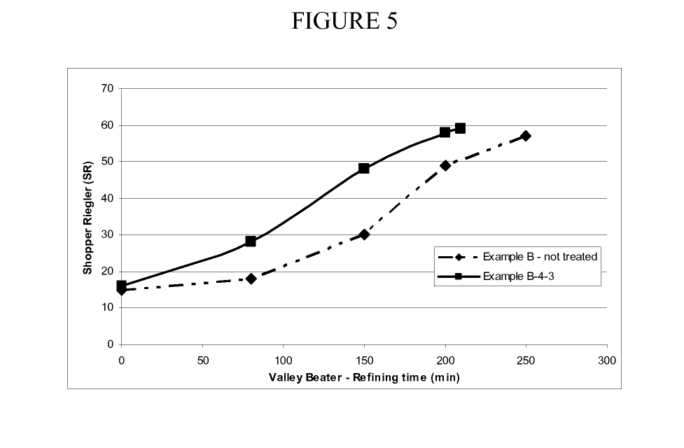

The results are shown graphically in FIG. 1 (R10-value) and FIG. 2 (R18-value) concerning the fiber of Example C, and FIG. 3 (R10-value) and FIG. 4 (R18-value concerning the fiber of Example B.

One can see that the R10-values and R18-values of lyocell fibers are significantly enhanced by a mercerisation treatment.

### Refining

Lyocell fibers were refined with a Valley Beater according to ISO 5264-1.

Pulp fibers were refined with a PFI U3000 mill according to ISO 5264-2.

A Schopper-Riegler-test was performed on the unmercerised fiber of Example B and the mercerised fiber according to Example B-4-3 above in a Valley Beater.

The results of the tests are shown in FIG. 3. One can clearly see that the mercerised fiber develops higher Schopper-Riegler-values within a shorter refining time This means that the mercerised lyocell fiber has a high degree of fibrillation.

### Paper Samples

Paper samples were prepared with a RAPID-KÖTHEN sheet former, according to EN ISO 5269/2.

Various papers were manufactured from the fibers as summarized above, optionally in a mixture with other constituents.

Further tests were made with papers employing non-mercerised lyocell fibers, as well as with papers containing other constituents.

The composition of the paper samples as well as the properties determined therein are summarized in the following tables:

TABLE 3
Examples according to the invention

| | | Ex. 1 | Ex. 2 | Ex. 3 | Ex. 4 | Ex. 5 | Ex. 6 | Ex. 7 | Ex. 8 |
|---|---|---|---|---|---|---|---|---|---|
| Paper | PVA binder, 1.1 dtex, 3 mm | | | | | | | | 15 |
| Composition, % | PVA fibers, 1.1 dtex, 2 mm | | | | | | | | 35 |
| | Eucalyptus pulp (CSF = 460 ml) | | | | | | | | |
| | Mercerised wood pulp (CSF > 700 ml) | | | | | | | | |
| | Cotton Linters pulp (CSF > 700 ml) | | | | | | | | |
| | Viscose fibers, 0.9 dtex, 3 mm | | | | | | | | |
| | Lyocell example C-1-1, 150 ml CSF | 100 | | | | | | | 50 |
| | Lyocell example C-1-3, 150 ml CSF | | 100 | | | | | | |
| | Lyocell example C-2-6, 150 ml CSF | | | 100 | | | | | |
| | Lyocell example C-3-2, 150 ml CSF | | | | 100 | | | | |
| | Lyocell example C-3-4, 150 ml CSF | | | | | 100 | | | |
| | Lyocell example B-1-3, 150 ml CSF | | | | | | 100 | | |
| | Lyocell example B-1-4, 150 ml CSF | | | | | | | 100 | |
| Paper | Basis weight, g/m² | 45 | 44 | 46 | 45 | 45 | 43 | 43 | 44 |
| properties | Thickness, μm | 101 | 99 | 102 | 101 | 108 | 105 | 105 | 124 |
| | Density, g/cm³ | 0.45 | 0.44 | 0.45 | 0.45 | 0.42 | 0.42 | 0.41 | 0.35 |
| | Porosity, % | 67 | 67 | 67 | 67 | 69 | 70 | 70 | 74 |
| | Weight Reduction rate in KOH, % | 5.2 | 5.0 | 3.9 | 2.8 | 3.5 | 5.0 | 3.5 | 2.8 |
| | Area Shrinkage rate in KOH, % | 4 | 2 | 1.4 | 1.7 | 2.4 | 2.7 | 1.2 | 1.9 |
| | Frazier Air Permeability, cm³/cm²/sec | 2.2 | 1.8 | 3.9 | 1.9 | 4.2 | 3.2 | 1.6 | 5.6 |

| | | Ex. 9 | Ex. 10 | Ex. 11 | Ex. 12 | Ex. 13 | Ex. 14 |
|---|---|---|---|---|---|---|---|
| Paper | PVA binder, 1.1 dtex, 3 mm | 15 | 15 | 15 | 15 | 15 | 15 |
| Composition, % | PVA fibers, 1.1 dtex, 2 mm | 35 | 35 | 35 | 35 | 35 | 35 |
| | Eucalyptus pulp (CSF = 460 ml) | | | | | | |
| | Mercerised wood pulp (CSF > 700 ml) | | | | | | |
| | Cotton Linters pulp (CSF > 700 ml) | | | | | | |
| | Viscose fibers, 0.9 dtex, 3 mm | | | | | | |
| | Lyocell example C-1-1, 150 ml CSF | | | | | | |
| | Lyocell example C-1-3, 150 ml CSF | 50 | | | | | |
| | Lyocell example C-2-6, 150 ml CSF | | 50 | | | | |
| | Lyocell example C-3-2, 150 ml CSF | | | 50 | | | |
| | Lyocell example C-3-4, 150 ml CSF | | | | 50 | | |
| | Lyocell example B-1-3, 150 ml CSF | | | | | 50 | |
| | Lyocell example B-1-4, 150 ml CSF | | | | | | 50 |
| Paper | Basis weight, g/m² | 45 | 44 | 44 | 42 | 43 | 44 |
| properties | Thickness, μm | 123 | 128 | 123 | 124 | 105 | 123 |
| | Density, g/cm³ | 0.37 | 0.34 | 0.36 | 0.34 | 0.41 | 0.36 |
| | Porosity, % | 73 | 75 | 74 | 75 | 70 | 74 |
| | Weight Reduction rate in KOH, % | 3.0 | 2.3 | 1.6 | 2.1 | 2.9 | 1.7 |
| | Area Shrinkage rate in KOH, % | 0.9 | 0.6 | 1.1 | 0.9 | 1 | 0.8 |
| | Frazier Air Permeability, cm³/cm²/sec | 6.1 | 9.2 | 12.3 | 14.3 | 25.2 | 13.6 |

TABLE 4
Comparison Examples

| | | Ex. 15 | Ex. 16 | Ex. 17 | Ex. 18 | Ex. 19 |
|---|---|---|---|---|---|---|
| Paper | PVA binder, 1.1 dtex, 3 mm | 15 | 15 | 15 | 15 | 15 |
| Composition, % | PVA fibers, 1.1 dtex, 2 mm | 35 | 35 | 35 | 35 | 35 |
| | Eucalyptus pulp (CSF = 460 ml) | | | 25 | | |
| | Mercerised wood pulp (CSF > 700 ml) | | | | | 50 |
| | Cotton Linters pulp (CSF > 700 ml) | | | | 50 | |
| | Viscose fibers, 0.9 dtex, 3 mm | | | 25 | | |
| | Lyocell Example B - Not Mercerised, 150 | 50 | | | | |
| | CSF | | | | | |
| | Lyocell Example C - Not Mercerised, 150 | | 50 | | | |
| | CSF | | | | | |
| Paper | Basis weight, g/m² | 46 | 45 | 45 | 46 | 47 |
| properties | Thickness, μm | 118 | 117 | 111 | 121 | 120 |
| | Density, g/cm³ | 0.38 | 0.4 | 0.41 | 0.38 | 0.39 |
| | Porosity, % | 70 | 72 | 70 | 72 | 71 |
| | Weight Reduction rate in KOH, % | 5.1 | 3.5 | 6.9 | 1.2 | 3.6 |
| | Area Shrinkage rate in KOH, % | 1.9 | 1.8 | 9 | 8.6 | 3.1 |
| | Frazier Air Permeability, cm³/cm²/sec | 7.2 | 8.7 | 28 | 60 | 71 |

Comparing Comparison Example 15 with Inventive Examples 13 and 14 and Comparison Example 16 with Inventive Examples 8 to 12, respectively, there is a remarkable reduction in the Weight Reduction rate in KOH obtained by employing mercerised lyocell fiber instead of non-mercerised lyocell fiber.

1. A battery separator, comprising fibers of the lyocell genus, wherein said lyocell fibers are mercerized.

2. The battery separator according to claim 1, wherein the R10-value and the R18-value of said lyocell fibers is as follows:
R10>87%,
R18>95%.

3. The battery separator according to claim 1 or 2, wherein the separator comprises a mixture of said lyocell fibers.

4. The battery separator according to claim 1 or 2, wherein the amount of said lyocell fibers in the separator is from 1% to 100%.

5. The battery separator according to claim 1 or 2, wherein the separator exhibits a Reduction by Weight in KOH of <3.5%.

6. The battery separator according to claim 1 or 2, wherein the separator exhibits a Reduction by Area in KOH of <3.0%.

7. The battery separator according to claim 1 or 2, wherein the separator exhibits a Frazier Air Permeability of <50 cm³/cm²/s.

8. A process for making a battery separator comprising employing a mercerized lyocell fiber.

9. The process according to claim 8, wherein the R10-value and the R18-value of said lyocell fiber is as follows:
R10>87%,
R18>95%.

10. A mercerized lyocell fiber, having a length of 2-10 mm.

11. The lyocell fiber according to claim 10, wherein the R10-value and the R18-value of said lyocell fiber is as follows:
R10>87%,
R18>95%.

12. A battery comprising the battery separator according to claim 1 or 2.

13. The battery separator according to claim 2, wherein the R10-value and the R18-value of said lyocell fibers is as follows:
R10>93%
R18>98%.

14. The battery separator according to claim 4, wherein the amount of said lyocell fibers in the separator is from 15% or more.

15. The battery separator according to claim 14, wherein the amount of said lyocell fibers in the separator is from 25% or more.

16. The battery separator according to claim 15, wherein the amount of said lyocell fibers in the separator is from 40% or more.

17. The battery separator according to claim 16, wherein the amount of said lyocell fibers in the separator is from or 50% or more.

18. The battery separator according to claim 5, wherein the battery separator exhibits a Reduction by Weight in KOH of 2.5% or less.

19. The battery separator according to claim 6, wherein the separator exhibits a Reduction by Area in KOH of 1.0% or less.

20. The battery separator according to claim 7, wherein the separator exhibits a Frazier Air Permeability of <20 cm³/cm²/s.

21. The battery separator according to claim 7, wherein the separator exhibits a Frazier Air Permeability of from 3.5 cm³/cm²/s to 15 cm³/cm²/s.

22. The process according to claim 9, wherein the R10-value and the R18-value of said lyocell fiber is as follows:
R10>93%
R18>98%.

23. The lyocell fiber according to claim 10, wherein the R10-value and the R18-value of said lyocell fiber is as follows:
R10>93%
R18>98%.

24. The battery according to claim 12, wherein the battery is an alkaline battery.
